(19) United States
(12) Patent Application Publication
(10) Pub. No.: US 2016/0173898 A1
(43) Pub. Date: Jun. 16, 2016

(54) Methods, Decoder and Encoder for Selection of Reference Pictures to be Used During Encoding

(71) Applicant: Telefonaktiebolaget L M Ericsson (publ), Stockholm (SE)

(72) Inventors: Jonatan Samuelsson, Strockholm (SE); Magnus WESTERLUND, VASBY (SE)

(21) Appl. No.: 14/436,531

(22) PCT Filed: May 13, 2014
(86) PCT No.: PCT/SE2014/050580

§ 371 Date: Apr. 17, 2015

(51) Int. Cl. H04N 19/44; H04N 19/423; H04N 19/89; H04N 19/70; H04N 19/105; H04N 19/172

(52) U.S. Cl. CPC H04N 19/44; H04N 19/105; H04N 19/172; H04N 19/89; H04N 19/70; H04N 19/423

(57) ABSTRACT

A method and an encoder (110) for selecting zero or more reference picture to be used when encoding one or more pictures into a Coded Video Sequence, “CVS” as well as a method and a decoder (120) for supporting the selection by the encoder (110) are disclosed. The encoder (110) encodes (201) pictures into the CVS. Furthermore, the encoder (110) sends (202) a picture of the CVS to a decoder (120), which determines (204) an indication indicative of an error in the picture. Next, the decoder (120) sends (212), to the encoder (110), a feedback message for supporting selection, by the encoder (110), of zero or more reference pictures to be used by the encoder (110) when encoding one or more pictures to create the CVS, wherein the feedback message comprises information relating to the indication. When the encoder (110) has received the feedback message, it encodes (214) pictures into the CVS based on the information relating to the indication while using zero or more reference pictures indicated by the identities of the reference pictures. Computer programs and carriers therefor are disclosed.

### TECHNICAL FIELD

Embodiments herein relate to video coding. In particular, a method and a decoder for supporting selection, by an encoder, of zero or more reference pictures to be used by the encoder when encoding one or more pictures to create a Coded Video Sequence (CVS) as well as a method and an encoder for selecting zero or more reference picture to be used when encoding one or more pictures into a CVS are disclosed. Moreover, corresponding computer programs and computer program products are disclosed.

### BACKGROUND

With video coding technologies, it is often desired to compress a video sequence into a coded video sequence. The video sequence may for example have been captured by a video camera. A purpose of compressing the video sequence is to reduce a size, e.g. in bits, of the video sequence. In this manner, the coded video sequence will require smaller memory when stored and/or less bandwidth when transmitted from e.g. the video camera. A so called encoder is often used to perform compression, or encoding, of the video sequence. Hence, the video camera may comprise the encoder. The coded video sequence may be transmitted from the video camera to a display device, such as a television set (TV) or the like. In order for the TV to be able to decompress, or decode, the coded video sequence, it may comprise a so called decoder. This means that the decoder is used to decode the received coded video sequence. In other scenarios, the encoder may be comprised in a network node of a cellular communication system and the decoder may be comprised in a wireless device, such as a cellular phone or the like, and vice versa.

A known video coding technology is called High Efficiency Video Coding (HEVC), which is a new video coding standard, recently developed by Joint Collaborative Team-Video Coding (JCT-VC). JCT-VC is a collaborative project between Moving Pictures Expert Group (MPEG) and International Telecommunication Union's Telecommunication Standardization Sector (ITU-T).

Furthermore, VP8 is known proprietary video coding technologies.

Common for the above two video coding technologies is that they use one or more previously decoded pictures for reference when decoding a current picture and that the encoder and decoder will keep bit-exact versions of some of these decoded pictures, called reference pictures, so as to avoid that any difference occurs between the encoder and the decoder, a.k.a. drift.

Pictures that do not use previously decoded pictures for reference are called intra pictures. Intra pictures can be used to reset the state of the decoder for example in order to recover from errors that have occurred in previously decoded pictures. In HEVC, intra pictures that do not allow pictures that follow the intra picture in output order to be reference pictures before the intra picture are called IRAP (Intra Random Access Point) pictures.

An HEVC bitstream, e.g. in the form of a Coded Video Sequence (CVS), includes one or more Network Abstraction Layer (NAL) units. A picture may be included in one or more NAL units. A bitstream comprises of a sequence of concatenated NAL units. A NAL unit type is transmitted in the nal_unit_type codeword in a NAL unit header, 2 bytes in HEVC. The NAL unit type indicates how the NAL unit should be parsed and decoded. There exist two types of NAL units: VCL (video coding layer) NAL units and non-VCL NAL units. One example of non-VCL NAL units is Supplemental Enhancement Information (SEI) messages. These messages contain meta data that does not affect the actual decoding process of video data. A particular SEI message is called Decoded Picture Hash (DPH) SEI message, which is specified in HEVC specification, section D.2.19 and D.3.19. The DPH SEI message defines three methods for calculating a hash, or a DPH value, over a decoded picture, which in the encoder is also referred to as the reconstructed picture: Message-Digest algorithm 5 (MD5), Cyclic Redundancy Check (CRC) and checksum. Which of them is used is indicated by the syntax element hash_type of the DPH SEI message.

Video Transport is done in various ways; two commonly used methods are Real-Time Transport Protocol (RTP) for real-time, often interactive communication, and Hypertext Transfer Protocol (HTTP) based video streaming for content services, serving video on demand.

RTP/Real-Time Control Protocol (RTCP), see Request For Comments (RFC) 3550, is a real-time media transport framework that provides various tools suitable for dealing with low-delay interactive video communication. These tools include feedback explicitly related to video coding and used to influence the video encoder. Below we shortly discuss some of these existing tools:

Reference Picture Selection Indication (RPSI), see RFC4585, is a tool for a receiver to indicate to a video encoder, please use this video picture as reference picture when encoding the next picture. It is used in the HEVC RTP payload format for the purpose of selecting another reference picture when a picture has been detected as erroneous. The VP8 RTP payload format uses RPSI also in an acknowledgment (ACK) mode, where it ACKs the reception of VP8's “golden” pictures, i.e. key reference pictures.

An RTP payload format is a specification for how a particular real-time media encoder is packetized within RTP.

The capabilities of both encoder and the decoders are commonly signalled to let the counter part know capabilities or request or require particular features to be enabled in the counter part as well as the media transport. For RTP based systems the most commonly used signalling is based on Session Description Protocal (SDP), see RFC 4566. The SDP may be part of Session Initiation Protocol (SIP) messages, see RFC 3261.

Consider a scenario in which an encoder sends a CVS to a decoder. Assume that the decoder finds that there is an error in a picture of the CVS, e.g. due to error states in the decoding process such as out-of-bound conditions or mismatch between a received DPH value, if a DPH SEI message has been sent by the encoder, and a calculated DPH value, which has been calculated by the decoder. Then, it is preferred that the error is resolved. When using RPSI to resolve the error (or errors), a problem may be that the decoder or the encoder uses a reference picture, as indicated by the RPSI, which is not correctly decoded and/or received by the decoder. In case, the reference picture is not error-free, a further error may be introduced, i.e. the further error is another error compared to what caused the RPSI to be sent in the first place.

Thus, video coding needs improvements in this regard. In particular, a problem may be how to avoid that the decoder or the encoder uses a reference picture, which is not correctly decoded and/or received by the decoder.

### SUMMARY

An object is to improve video coding.

According to a first aspect, the object is achieved by a method, performed by a decoder, for supporting selection, by an encoder, of zero or more reference pictures to be used by the encoder when encoding one or more pictures to create a Coded Video Sequence (CVS). The decoder receives a picture of the CVS from the encoder. The decoder determines an indication indicative of an error in the picture. Furthermore, the decoder sends, to the encoder, a feedback message for supporting selection, by the encoder, of zero or more reference pictures to be used by the encoder when encoding one or more pictures to create the CVS, wherein the feedback message comprises information relating to the indication indicative of the error.

According to a second aspect, the object is achieved by a method, performed by an encoder, for selecting zero or more reference picture to be used when encoding one or more pictures into a CVS. The encoder encodes pictures into the CVS and sends a picture of the CVS to a decoder. Furthermore, the encoder receives, from the decoder, a feedback message comprising information relating to an indication indicative of an error in the picture and identities of reference pictures of the decoder. Then, the encoder encodes pictures into the CVS based on the information relating to the indication indicative of the error while using zero or more reference pictures indicated by the identities of the reference pictures.

According to a third aspect, the object is achieved by a decoder configured to support selection, by an encoder, of zero or more reference pictures to be used by the encoder when encoding one or more pictures to create a CVS. The decoder is configured to receive a picture of the CVS from the encoder, and to determine an indication indicative of an error in the picture. Moreover, the decoder is configured to send, to the encoder, a feedback message for supporting selection, by the encoder, of zero or more reference pictures to be used by the encoder when encoding one or more pictures to create the CVS, wherein the feedback message comprises information relating to the indication indicative of the error.

According to a fourth aspect, the object is achieved by an encoder configured to select zero or more reference picture to be used when encoding one or more pictures into a CVS. The encoder is configured to encode pictures into the CVS, and to send a picture of the CVS to a decoder. Furthermore, the encoder is configured to receive, from the decoder, a feedback message comprising information relating to an indication indicative of an error in the picture and identities of reference pictures of the decoder. Moreover, the encoder is configured to encode pictures into the CVS based on the information relating to the indication indicative of the error while using zero or more reference pictures indicated by the identities of the reference pictures.

According to further aspects, the object is achieved by computer programs and carriers for computer programs corresponding to the aspects above.

The decoder sends, to the encoder, a feedback message, which differs from known feedback messages in that the feedback message comprises information relating to the indication indicative of the error. As an example, the feedback message may be an RPSI message, i.e. an extended RPSI message compared to the existing specification, which may include a new field for the indication indicative of the error. The feedback message may also be a new message configured to carry information, such as one or more of the indication indicative of the error, the identities of reference pictures, or the like, as disclosed herein.

Thanks to the indication indicative of the error, the decoder and/or the encoder, as will be evident from the various embodiments described herein, is able to determine which reference pictures have been correctly decoded by the decoder. As mentioned above, it may be beneficial for the encoder to be aware of these correctly decoded reference pictures when encoding one or more pictures into the CVS, since otherwise the decoder may not be able to correctly decode the CVS to obtain the pictures.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is a schematic overview of an exemplifying system in which embodiments herein may be implemented,

FIG. 2a is a schematic, combined signaling scheme and flowchart illustrating embodiments of the methods when performed in the system according to FIG. 1,

FIG. 2b is a detailed view of a portion of the combined signalling scheme and flowchart of FIG. 2a,

FIG. 3 is a flowchart illustrating embodiments of the method in the decoder,

FIG. 4 is a block diagram illustrating embodiments of the decoder.

FIG. 5 is a flowchart illustrating embodiments of the method in the encoder, and

FIG. 6 is a block diagram illustrating embodiments of the encoder.

### DETAILED DESCRIPTION

In order to solve the above mentioned problem, it may be possible to send a DPH SEI message with each picture. However, such a DPH SEI message consumes bandwidth, in terms of bitrate, in the direction from the encoder to the decoder. This is not preferred in some scenarios, since the bandwidth may in this direction preferably be used for carrying video information. A problem may hence be how to ensure that the reference pictures are correct while at the same time keeping bandwidth consumption low. This problem is solved by some embodiments herein.

Throughout the following description similar reference numerals have been used to denote similar elements, units, modules, circuits, nodes, parts, items or features, when applicable. In the Figures, features that appear in some embodiments are indicated by dashed lines.

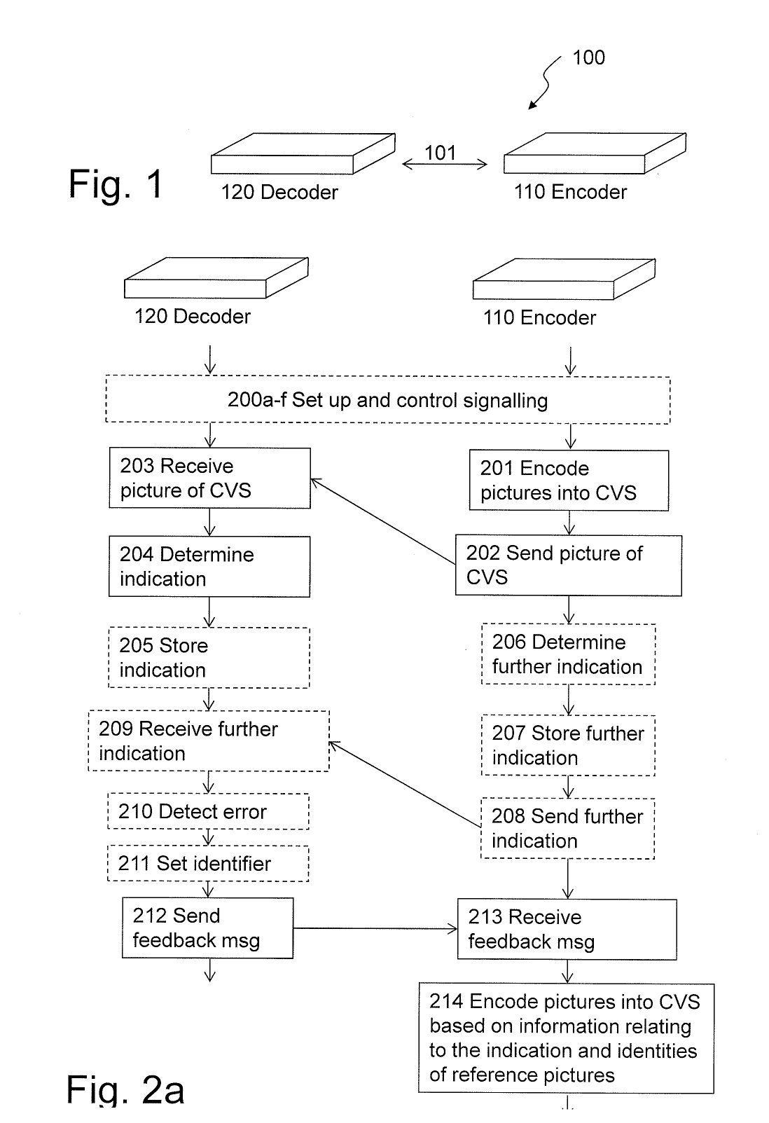

FIG. 1 depicts an exemplifying system 100 in which embodiments herein may be implemented. In this example, the system 100 comprises an encoder 110 and a decoder 120. The encoder 110 and/or the decoder 120 may be comprised in various platforms, such as television set-top-boxes, video players/recorders, video cameras, Blu-ray players, Digital Versatile Disc (DVD)-players, media centers, media players, user equipments and the like. As used herein, the term “user equipment” may refer to a mobile phone, a cellular phone, a Personal Digital Assistant (PDA) equipped with radio communication capabilities, a smartphone, a laptop or personal computer (PC) equipped with an internal or external mobile broadband modem, a tablet PC with radio communication capabilities, a portable electronic radio communication device, a sensor device equipped with radio communication capabilities or the like. The sensor may be a microphone, a loudspeaker, a camera sensor etc.

Accordingly, in some embodiments a source device may implement some of the actions and/or features described herein. The source device may in such case comprise an encoder, which does not implement the actions and/or features described herein. In effect, embodiments herein are performed by the source device which provides control logic at a level above the encoder, i.e. at a level closer to, or in, a so called application layer. Similarly, in some embodiments a target device may implement some of the actions and/or features described herein. The target device may in such case comprise a decoder, which does not implement the actions and/or features described herein. In effect, embodiments herein are performed by the target device which provides control logic at the level above the encoder. In this manner, advantages described herein may be provided with encoders and/or decoders according to existing standard specifications.

As an example, the encoder 110 may send 101, over a wired or wireless connection, a bitstream to the decoder 120. The bitstream may be video data, e.g. in the form of one or more NAL units. The video data may thus for example represent pictures of a video sequence. In case of HEVC, the bitstream comprises a coded video sequence that is HEVC compliant.

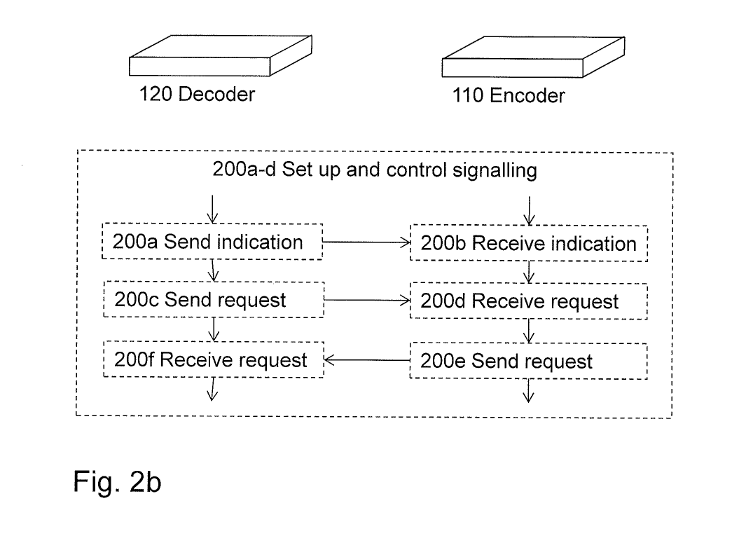

FIG. 2a illustrates exemplifying methods according to embodiments herein when implemented in the decoder 110 and encoder 120, respectively of the system 100 of FIG. 1.

The encoder 110 performs a method for selecting zero or more reference picture to be used when encoding one or more pictures into a Coded Video Sequence, “CVS” and the decoder 120 performs a method for supporting selection, by the encoder 110, of zero or more reference pictures to be used by the encoder 110 when encoding one or more pictures to create the CVS.

According to some embodiments, the encoder 110 sends for some or all pictures e.g. a hash value. The hash value, which may be a DPH value, is referred to as a further indication in the description relating to FIG. 2. These embodiments are referred to as “inband-embodiments”.

According to some other embodiments, the encoder 110 does not send the hash value as explained for the inband-embodiments mentioned directly above. These embodiments are referred to as “no-inband-embodiments”.

According to some embodiments, the decoder 120 sends for some or all received pictures an ACK-message to the encoder 110. This enables the encoder 110 to verify whether or not the picture has been received and decoded correctly at the decoder 120. These embodiments are referred to as “ACK-embodiments”. The ACK-embodiments may be combined with the inband- or no-inband-embodiments.

With these embodiments, and other embodiments, in mind, the combined signalling and flowchart of FIG. 2a will be described in the following.

The following actions may be performed in any suitable order.

### Action 200a Through 200f

These actions include set up and control signalling, such as one or more of actions 200a-200f in FIG. 2b below. Set up and control signalling may be performed at any time if necessary, i.e. even though here illustrated as initial actions, these actions may in some embodiments be performed after any one of the following actions as deemed suitable, e.g. after action 210 and/or after action 213. For example, one or more of actions 200a-200f may be performed as a result of change of connection between the encoder and the decoder, e.g. the connection may change from wired to wireless, or from cellular to WiFi due to different data rates, cost of data etc.

### Action 201

In order to generate a CVS, the encoder 110 encodes pictures into the CVS. The CVS may comprise one or more NAL units.

### Action 202

When action 201 has been performed, the encoder 110 sends a picture of the CVS to a decoder 120. The picture may be comprised in one or more NAL units of the CVS.

### Action 203

Subsequent to action 202, the decoder 120 receives the picture of the CVS from the encoder 110.

### Action 204

In order to be able check for errors in the received picture in action 210, the decoder 120 determines an indication indicative of an error in the picture. The indication is indicative of the error in that the indication enables e.g. the decoder 120 to verify whether or not the picture, in its reconstructed format, has been correctly decoded. As an example, the indication may comprise a hash value for the picture, such as checksum, Cyclic Redundancy Check (CRC), MD5 or the like which are known from HEVC specifications, i.e. H.265-201304, Annex D, Section D. 3.19, page 273-274.

The errors in video decoding, occurring in the picture, have two major sources.

The first source is data errors in the encoded video data feed as input to the decoder. These errors can be introduced at any stage between the encoder's output and the decoder's input. Transport over an IP-network, like the Internet is one potential cause for these errors, primarily when the data's integrity isn't verified by the receiver. These errors occur even over “reliable” transports like TCP that has some (but weak) error detection capabilities. Other causes for errors are the hardware, where memory or storage without strong verification can introduce bit-errors or other modifications.

The second source for errors is errors in the decoding process. These are not supposed to be there, but a decoder is an implementation of a standard. This means that there may be errors in both the interpretation of the standard, as well as in the implementation.

Some of the errors do result in that the decoder itself detects them, for example a value that is not allowed, or output values that are out-of-bounds. This indicates to the decoder that the decoding of this video picture failed to some degree. However, in other cases the decoder does not detect these, and outputs a video picture and continues to use the corrupted state to decode further images. These later errors thus can pass the decoding and significantly lower the video quality for significant durations.

### Action 205

In order to keep track of the indication, indicative of error, for the picture, the decoder 120 may store the indication. This action may be performed only for reference pictures according to some embodiments. The reference pictures may be any kind of pictures that are enable efficient encoding and/or decoding. Hence, thanks to that the indication indicative of the error is stored, the indication indicative of the error may be recalled at a later stage, e.g. to be used in action 210 and/or 212.

### Action 206

Now returning to the actions in the encoder, the encoder 110 may determine a further indication, mentioned briefly above, indicative of the error in the picture. The further indication may relate to the feedback message in action 213 or it may be used in action 214 below. The further indication may comprise a further hash value for the picture.

### Action 207

The encoder 110 may store the further indication. Thus, the further indication may be recalled at a later stage, such as in action 214.

### Action 208

According to the inband-embodiments, the encoder 110 may send the further indication to the decoder 120. This action may be performed either periodically, to limit number of pictures in which an error can propagate in, or selectively only for those pictures that the encoder 110 considers to be important pictures, e.g. pictures more likely to be used as reference pictures. Examples of important pictures includes intra pictures, RAP pictures, IDR pictures or pictures with TemporalId equal to 0 that are not RASL pictures, RADL pictures, or sub-layer non-reference pictures. This enables the decoder 120 to detect decoding errors which otherwise would not be detected.

### Action 209

Subsequent to action 208 also according to the inband-embodiments, the decoder 120 may receive the further indication from the encoder 110.

### Action 210

The decoder 120 may detect an error in the picture.

With the no-inband-embodiments, the DPH SEI message may be completely omitted from the CVS, e.g. an encoder-to-decoder video bit-stream, i.e. action 208 above is not performed. Instead, a bit-rate cost for hashes are only carried in the decoder-to-encoder direction, e.g. as in action 212 below. This is efficient from bandwidth perspective. However, the error detection, in this action, may typically be limited what the decoder 120 may determine itself based on missing input, e.g. commonly packet losses, and exceptions or out-of-bounds conditions when decoding. Thus, in these embodiments no validation of the picture may be performed in the decoder 120.

Moreover, such as with the “no-inband-embodiments”, a check of the validity of the received picture may be performed by the encoder 110 in connection with at least parts of action 214 below if the feedback message in action 212 includes the indication determined in action 204.

However, according to the inband-embodiments, the decoder 120 may detect, e.g. check the validity of the received picture by comparing the further indication, received in action 209, to the indication, determined in action 204. Thus, when actions 208 and 209 have been performed, the decoder 120 may detect the error by setting the identifier as in action 211 below.

### Action 211

E.g. according to the inband-embodiments, the information of the feedback message may comprise an identifier for indicating that the picture is error-free or for indicating that the picture is erroneous. This means that identifier may indicate whether or not the picture is valid, e.g. correctly decoded and/or the indication, indicative of error, matches the further indication as below.

The decoder 120 may set the identifier to indicate that the picture is error-free, when the indication matches the further indication. This means that the decoder 120 has not detected the error since the picture is correctly decoded by the decoder 120.

The decoder 120 may set the identifier to indicate that the picture is erroneous, when the indication is different from the further indication. Accordingly, this means that the decoder 120 has detected the error e.g. due to encoder-decoder incompatibility.

### Action 212

In order to inform the encoder, either explicitly or implicitly, about which pictures, in particular reference pictures, that have been correctly decoded, the decoder 120 sends, to the encoder 110, a feedback message for supporting selection, by the encoder 110, of zero or more reference pictures to be used by the encoder 110 when encoding one or more pictures to create the CVS. The feedback message comprises information relating to the indication.

The feedback message may comprise a RTCP feedback message, such as a RPSI message.

When explicitly informing the encoder 110, actions of the inband-embodiments have been performed. This means e.g. that action 208 has been performed. Moreover, the explicit information may be given by the identifier set in action 211.

The identifier may thus be a flag, which may be called hash_verified_flag. The value 1 of hash_verified_flag may indicate that the hash value has been calculated for the decoded picture by the decoder 120 and that the hash value matches the one sent, in action 208, in the DPH SEI message. The value 0 of hash_verified_flag may indicate that the decoder 120 has not verified the hash value either because there was no DPH SEI message or because the decoder 120 did not have capabilities or resources to calculate the decoded picture hash, i.e. determine the indication as in action 204, for that picture.

In one embodiment, the RPSI message in the HEVC payload format is extended with the possibility to indicate if the DPH SEI message has been used by the decoder 120 to verify that the decoded picture is correct.

This is preferably combined with further extending the RPSI message in the HEVC payload format to support indication of multiple pictures used as reference pictures. In the existing RPSI message in the HEVC payload format, it is only possible to indicate one reference picture.

Two bits directly preceding nuh_layer_id in the “Native RPSI bit string defined per codec” may be used to indicate information about a hash status, such as given by the identifier above, of that specific reference picture.

One value of those 2 bits, e.g. 0b00, would indicate that there is no information included regarding the hash value of the decoded picture for example because the decoder did not calculate the decoded picture hash value for that picture. Another value of those 2 bits, e.g. 0b01, would indicate that the decoded picture hash has been verified to be correct by the decoder 120.

An advantage with the embodiments, in which the identifier is implemented, may be that the encoder 110 has explicit knowledge of which out of potentially many reference pictures that have been correctly decoded by the decoder 120. Thus, the identifier enables the encoder 110 to use only correct, i.e. validated, reference pictures when encoding a subsequent picture. Here, subsequent may mean subsequent in time of a video sequence to be encoded, or subsequent in that the subsequent picture is to be sent to the decoder in the form of a new representation of the same video sequence. By providing the identifier for multiple reference pictures and allowing the encoder 110 to use those reference pictures that provides the most efficient encoding maximizes the encoding efficiency given the constraints.

When implicitly informing the encoder 110, e.g. according to the no-inband-embodiments, the feedback message relates to the indication only. In more detail, the information of the feedback message may comprise the indication. The informing is implicit, because the information sent by the decoder 120 does not specify which reference pictures are correct in decoder 120, but merely enable the encoder 110 to determine which reference pictures in the decoder 120 are correct.

The RPSI message in the HEVC payload format, taken as an example as mentioned above, may be extended with the possibility to include the indication of a decoded picture in order for the encoder 110 to verify, or validate, that the picture decoded by the decoder (receiver) is correct. This is preferably combined with further extending the RPSI message in the HEVC payload format to support indication of multiple pictures used as reference pictures.

Two bits, directly preceding nuh_layer_id in the “Native RPSI bit string defined per codec”, may be used to indicate information about the hash status of that specific reference picture, such as by use of the identifier.

One value of those 2 bits, e.g. 0b00, may indicate that no hash value is sent together with the indication of the reference picture. Another value of those 2 bits, e.g. 0b10, would indicate that the decoded picture hash is included in the RPSI together with an identity of the reference picture. The decoded picture hash would then preferably be included in the RPSI message directly following the identity of the reference picture, i.e. the PicOrderCntVal. The PicOrderCntVal (POC) is a picture order count for identification of in which order the pictures in the CVS are to be output (displayed).

A hash_type may be predefined in the HEVC payload format, for example such that it would always be MD5. Thus, it would always be 16 bytes of data per picture.

The hash_type may be determined by the payload type and the length would thereby always be the same for the same RTP stream.

The hash_type may be indicated by a field in the RPSI message and the length depends on the value of that field, i.e. 16 bytes for MD5, 2 bytes for CRC and 4 bytes for checksum.

In addition to the advantage mentioned above, a further advantage with the embodiments, in which the feedback message comprises the indication, is that the DPH SEI message may be excluded from the CVS. Hence, the hash information, i.e. in the form of the indication, for the reference pictures is only transmitted when required to be determined, by the encoder 110, if a reference picture is correct or not, i.e. valid or not valid.

Hence, when the encoder 110 receives the feedback message, it checks for each of the received reference pictures if that reference picture still exists in a reference picture buffer of the encoder 110. If it does, the encoder 110 checks the indication included in the feedback message against the determined further indication, e.g. stored in the encoder 110. If these indications match, the reference picture is validated, e.g. error-free and available, and can be used to encode the next picture. This may be done for all reference picture identified by the identities included in the feedback message. This thus results in that the encoder 110 has explicit knowledge which, if any, of the encoder's reference pictures that are correct in the decoder 120. When the reference picture is said to be available, it may mean that the reference picture is present in a decoded picture buffer of the encoder/decoder. Again, if there are any valid reference pictures, then the encoder 110 can use those in encoding the next video picture. If there are no valid reference pictures, the encoder may encode an Intra picture or start a period of gradual decoder refresh.

The explicit and implicit ways of informing the encoder may be combined, referred to as combined embodiment below. Thus, the RPSI message may be extended to include both explicit and implicit ways of information the encoder.

This means that two bits directly preceding nuh_layer_id in the “Native RPSI bit string defined per codec” may be used to indicate information about the hash status of that specific reference picture, e.g. identifier as mentioned above.

A first value of those 2 bits, e.g. 0b00, may indicate that no hash value is sent together with the indication of the reference picture, for example because the decoder did not calculate the decoded picture hash value for that picture.

A second value of those 2 bits, e.g. 0b01, would indicate that the decoded picture hash has been verified to be correct by the decoder 120. A third value of those 2 bits, e.g. 0b10, would indicate that the decoded picture hash is included in the RPSI together with the indication of the reference picture. The decoded picture hash would then preferably be included in the RPSI message directly following the indication of the reference picture, i.e. the PicOrderCntVal.

In addition to the advantages mentioned above, an advantage of these combined embodiments is that it enables selected usage of DPH SEI message in the CVS. Thus, these embodiments may avoid having to unnecessary send the indication in the feedback message when the further indication has been included in the DPH SEI message received by the decoder 120.

As mentioned in the summary-section, the feedback message may be a new message introduced to provide the encoder 110 with information related to the indication, such as a DPH value, but which is not necessarily intended to be used for selection, in the encoder 110, of reference pictures.

The new message may be an ACK message indicating that “the picture has been received, decoded and verified with respect to the hash value of this picture”. The new message may at least comprise an identity of which picture it is. The identity may be a so called PicOrderCntVal.

Alternatively or additionally, the ACK message may indicate that “the picture has been received, decoded and here is the indication of this picture, e.g. the DPH value of this picture”. The message may in this case comprise at least an identity of which picture it is, such as the PicOrderCntVal, and a hash value, as an example of the indication, for that picture. The ACK message may further comprise a field providing information about the hash_type.

An advantage with the embodiments, in which the feedback message is the new message, may be that it provides the encoder 110 with information about which reference pictures are available and successfully decoded, i.e. which reference pictures are valid and present in the so called decoded picture buffer of the decoder 120.

The transmission of the ACK message may be triggered by that the decoder 120 has received a DPH SEI message from the encoder 110. This means that the decoder 120 only sends the ACK message for a picture for which there is a DPH SEI message in the CVS received by the decoder 120. Advantageously, a rate of acknowledgments may be controlled by the encoder 110. Thus, efficient usage of a potentially limited feedback bandwidth, or bitrate, may be achieved.

When action 210 has been performed, action 212 may be performed in response to the detection of the error in the picture, which detection may be in the affirmative, i.e. the picture is not correct in the decoder 120.

Action 212 may be performed when the picture is a key picture. As an example, this may be the case for the ACK-embodiments. In e.g. VP8, the key picture may be a so called golden picture. In other examples, the key picture may be any kind of reference picture.

The feedback message may comprise identities of reference pictures corresponding to the information relating to the indication.

### Action 213

The encoder (110) receives, from the decoder (120), the feedback message comprising information relating to the indication indicative of the error in the picture and identities of reference pictures of the decoder (120).

### Action 214

The encoder (110) encodes pictures into the CVS based on the information relating to the indication indicative of the error while using zero or more reference pictures indicated by the identities of the reference pictures.

When action 206 has been performed, the encoder 110 may encode pictures further based on the further indication.

Alternatively, when action 206 has been performed, the information further relates to the further indication.

Action 214 may be that the encoder 110 encodes the pictures into the CVS by using only one or more reference pictures for which the indication indicates that no error has been detected for said one or more reference pictures, or for which the indication and the further indication indicate that no error has been detected for said one or more reference pictures.

In case none of the reference pictures is indicated as that no error has been detected, then the encoder 110 may conclude that the encoder 110 needs to re-establish reference pictures by using encoding tools that doesn't rely on references to previously decoded pictures, e.g. encode an intra picture.

FIG. 2b shows a schematic combined signalling and flowchart, illustrating set up and control signalling in the system 100 of FIG. 1.

The following actions may be performed in any suitable order.

### Action 200a

The decoder 120 may send, to the encoder 110, an indication indicative of capability to send the feedback message. The indication indicative of capability may be sent using SDP.

### Action 200b

The encoder 110 may receive the indication indicative of capability when action 200a has been performed. Thus, the encoder 110 may refrain from sending so called inband DPH SEI messages in case the indication indicative of capability informs the encoder 110 about that the decoder is not capable of sending the feedback message. Thus, valuable bandwidth may be saved, while no inband DPH SEI messages are wasted towards a decoder 120 which is not capable of sending the feedback message.

### Action 200c

The decoder 120 may send, to the encoder 110, a request for inclusion, by the encoder 110, to include at least one DPH SEI message in the CVS. The request may be sent using SDP

### Action 200d

The encoder 110 may receive the request when action 200c has been performed. Also in this case, bandwidth in the direction from the encoder 110 to the decoder 120 may be saved, since the decoder 120 may preferably only request the encoder 110 to send DPH SEI messages when the decoder is capable of sending the feedback message in response to e.g. a detection of error, as in action 210.

### Action 200e

The encoder 110 may send a request for configuration of the decoder 120 to send the feedback message. The request may be sent using SDP.

### Action 200f

The decoder 120 may receive the request for configuration of the decoder 120 when action 200e has been performed. In this manner, it may be ensured that the decoder 120 only sends the feedback message when requested to do so by the encoder 110. Thus, bandwidth in the direction from the decoder 120 towards the encoder 110 may be saved, e.g. to be used for other purposes for the benefit of video encoding, or to be used by other services. It may be that action 200f may be particularly useful when the feedback message comprises the indication indicative of the error.

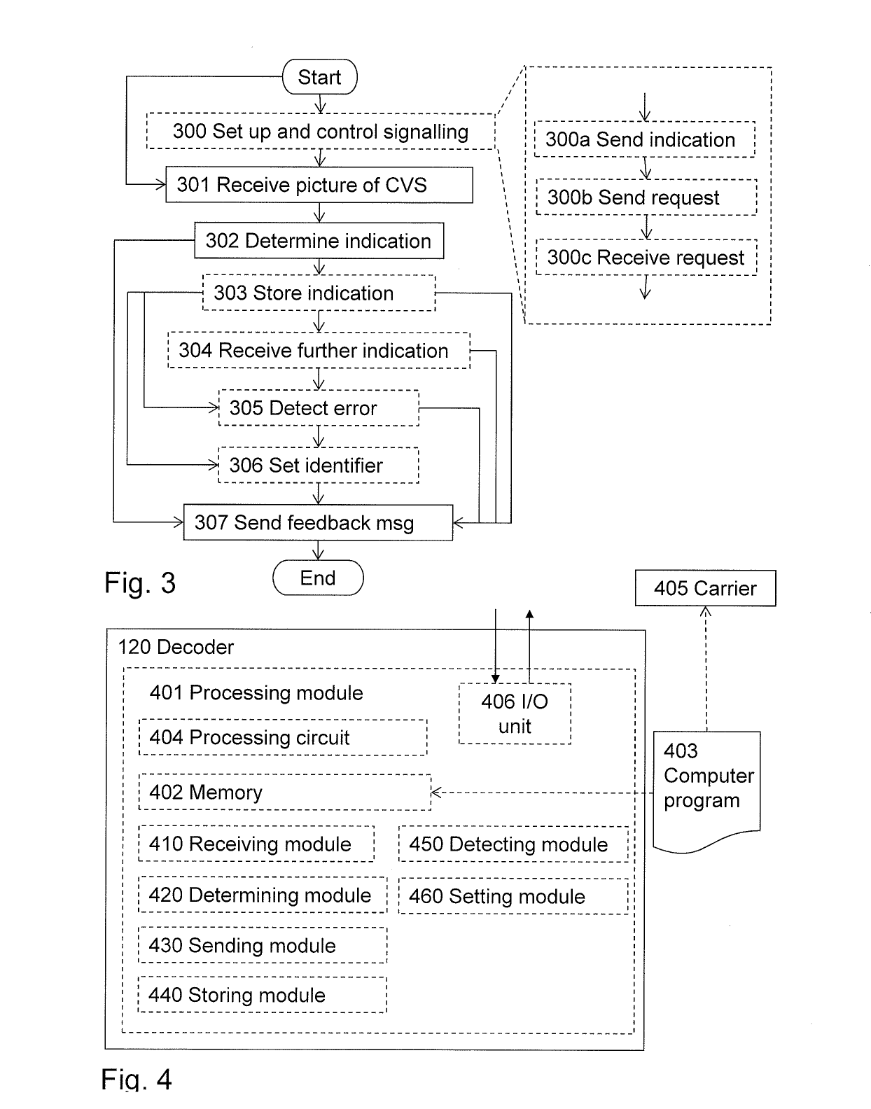

In FIG. 3, an exemplifying, schematic flowchart of embodiments of the method in the decoder 120 is shown. As mentioned, the decoder 120 performs a method for supporting selection, by an encoder 110, of zero or more reference pictures to be used by the encoder 110 when encoding one or more pictures to create a CVS.

As mentioned, the indication may comprise a hash value for the picture. The information of the feedback message may comprise the indication. The feedback message may comprise identities of reference pictures. The further indication may comprise a further hash value for the picture. The information of the feedback message may comprise an identifier for indicating that the picture is error-free or for indicating that the picture is erroneous. The feedback message may comprise a RTCP feedback message. The RTCP feedback message may comprise a

Reference Picture Selection Indication RPSI message. The CVS may be a HEVC compliant CVS.

The following actions may be performed in any suitable order.

### Action 300

This action includes set up and control signalling, such as one or more of actions 300a-300c below. Set up and control signalling may be performed at any time if necessary, i.e. even though here illustrated as initial actions, these actions may in some embodiments be performed after any one of the following actions, as deemed suitable, e.g. after action 305.

### Action 300a

The decoder 120 may send, to the encoder 110, an indication indicative of capability to send the feedback message. The indication indicative of capability may be sent using SDP. This action is similar to action 200a.

### Action 300b

The decoder 120 may send, to the encoder 110, a request for inclusion, by the encoder 110, to include at least one DPH SEI message in the CVS. The request may be sent using SDP. This action is similar to action 200c.

### Action 300c

The decoder 120 may receive, from the encoder 110, a request for configuration of the decoder 120 to send the feedback message. This action is similar to action 200f.

### Action 301

The decoder 120 receives a picture of the CVS from the encoder 110. This action is similar to action 203.

### Action 302

The decoder 120 determines an indication indicative of an error in the picture. This action is similar to action 204.

### Action 303

The decoder 120 may store the indication. This action is similar to action 205.

### Action 304

The decoder 120 may receive a further indication indicative of the error in the picture. This action is similar to action 209.

### Action 305

The decoder 120 may detect an error in the picture, wherein the sending of the feedback message is performed in response to the detection of the error in the picture. This action is similar to action 210.

### Action 306

The decoder 120 may set the identifier to indicate that the picture is error-free, when the indication matches the further indication.

The decoder 120 may set the identifier to indicate that the picture is erroneous, when the indication is different from the further indication.

These actions are similar to action 211.

### Action 307

The decoder 120 sends, to the encoder 110, a feedback message for supporting selection, by the encoder 110, of zero or more reference pictures to be used by the encoder 110 when encoding one or more pictures to create the CVS, wherein the feedback message comprises information relating to the indication. This action is similar to action 212.

The sending of the feedback message may be performed when the picture is a key picture.

With reference to FIG. 4, a schematic block diagram of the decoder 120 is shown. The decoder 120 is configured to support selection, by an encoder 110, of zero or more reference pictures to be used by the encoder 110 when encoding one or more pictures to create a CVS.

As mentioned, the indication may comprise a hash value for the picture. The information of the feedback message may comprise the indication. The feedback message may comprise identities of reference pictures. The further indication may comprise a further hash value for the picture. The information of the feedback message may comprise an identifier for indicating that the picture is error-free or for indicating that the picture is erroneous. The feedback message may comprise a RTCP feedback message. The RTCP feedback message may comprise a Reference Picture Selection Indication RPSI message. The CVS may be a HEVC compliant CVS.

The decoder 120 may comprise a processing module 401, such as a means, one or more hardware modules and/or one or more software modules for performing the methods described herein.

The decoder 120 may further comprise a memory 402. The memory may comprise, such as contain or store, a computer program 403.

According to some embodiments herein, the processing module 401 comprises, e.g. ‘is embodied in the form of’ or ‘realized by’, a processing circuit 404 as an exemplifying hardware module. In these embodiments, the memory 402 may comprise the computer program 403, comprising computer readable code units executable by the processing circuit 404, whereby the decoder 120 is operative to perform the methods of FIG. 2a/b and/or FIG. 3.

In some other embodiments, the computer readable code units may cause the decoder 120 to perform the method according to FIG. 2a/b and/or 3 when the computer readable code units are executed by the decoder 120.

FIG. 4 further illustrates a carrier 405, comprising the computer program 403 as described directly above. The carrier 405 may be one of an electronic signal, an optical signal, a radio signal, and a computer readable medium.

In some embodiments, the processing module 401 comprises an Input/Output (I/O) unit 406, which may be exemplified by a receiving module and/or a sending module as described below when applicable.

In further embodiments, the decoder 120 and/or the processing module 401 may comprise one or more of a receiving module 410, a determining module 420, a sending module 430, a storing module 440, a detecting module 450 and a setting module 450 as exemplifying hardware modules. In other examples, the aforementioned exemplifying hardware module may be implemented as one or more software modules.

Therefore, according to the various embodiments described above, the decoder 120 is operative to and/or the decoder 120, the processing module 401 and/or the receiving module 410 is configured to receive a picture of the CVS from the encoder 110.

The decoder 120 is operative to and/or the decoder 120, the processing module 401 and/or the determining module 420 is configured to determine an indication indicative of an error in the picture.

The decoder 120 is operative to and/or the decoder 120, the processing module 401 and/or the sending module 430 is configured to send, to the encoder 110, a feedback message for supporting selection, by the encoder 110, of zero or more reference pictures to be used by the encoder 110 when encoding one or more pictures to create the CVS, wherein the feedback message comprises information relating to the indication indicative of the error.

The decoder 120 may be operative to and/or the decoder 120, the processing module 401 and/or the storing module 440 may be configured to store the indication.

The decoder 120 may be operative to and/or the decoder 120, the processing module 401 and/or the detecting module 450 may be configured to detect an error in the picture. Then, the decoder 120 may be operative to and/or the decoder 120, the processing module 401 and/or the sending module 430, or another sending module (not shown) may be configured to send the feedback message in response to the detection of the error in the picture.

The decoder 120 may be operative to and/or the decoder 120, the processing module 401 and/or the receiving module 410, or another receiving module (not shown), may be configured to receive a further indication indicative of the error in the picture.

The decoder 120 may be operative to and/or the decoder 120, the processing module 401 and/or the setting module 460 may be configured set the identifier to indicate that the picture is error-free, when the indication matches the further indication.

The decoder 120 may be operative to and/or the decoder 120, the processing module 401 and/or the setting module 460 may be configured set the identifier to indicate that the picture is erroneous, when the indication is different from the further indication.

The decoder 120 may be operative to and/or the decoder 120, the processing module 401 and/or the sending module 430 may be configured send the feedback message when the picture is a key picture.

The decoder 120 may be operative to and/or the decoder 120, the processing module 401 and/or the sending module 430 may be configured send the feedback message. The indication indicative of capability may be sent using SDP, i.e. the decoder may be configured to send the indication indicative of capability using SDP.

The decoder 120 may be operative to and/or the decoder 120, the processing module 401 and/or the sending module 430 may be configured send, to the encoder 110, a request for inclusion, by the encoder 110, of at least one DPH SEI message in the CVS. The request may be sent using SDP.

The decoder 120 may be operative to and/or the decoder 120, the processing module 401 and/or the receiving module 410, or a still other receiving module (not shown), may be configured to receive, from the encoder 110, a request for configuration of the decoder 120 to send the feedback message. The request may be sent using SDP.

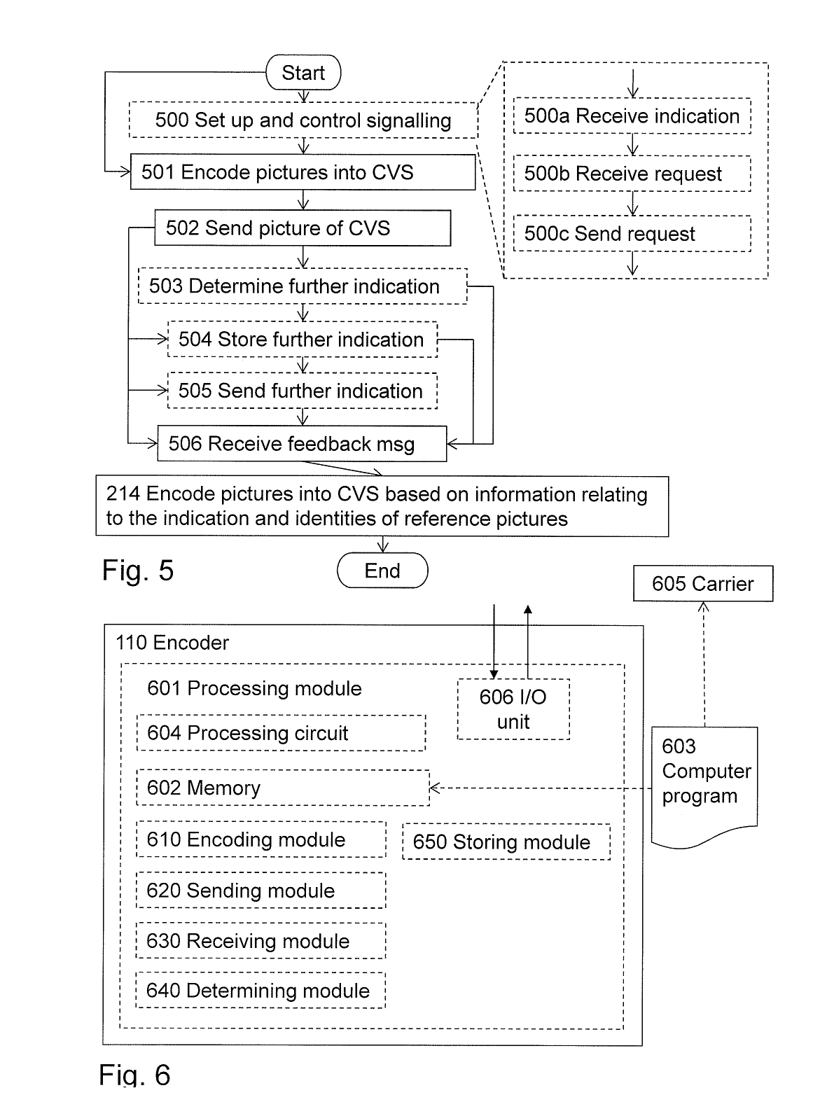

In FIG. 5, an exemplifying, schematic flowchart of embodiments of the method in the encoder 110 is shown. As mentioned, the encoder 110 performs a method for selecting zero or more reference picture to be used when encoding one or more pictures into a CVS.

As mentioned, the information of the feedback message may comprise the indication. The indication may comprise a hash value for the picture. The further indication may comprise a further hash value for the picture. The information of the feedback message may comprise an identifier for indicating that the picture is error-free or for indicating that the picture is erroneous. The feedback message may comprise a RTCP feedback message. The RTCP feedback message may comprise a Reference Picture Selection Indication RPSI message. The coded video sequence may be a HEVC compliant coded video sequence.

The following actions may be performed in any suitable order.

### Action 500

This action includes set up and control signalling, such as one or more of actions 500a-500c below. Set up and control signalling may be performed at any time if necessary, i.e. even though here illustrated as initial actions, these actions may in some embodiments be performed after any one of the following actions, as deemed suitable, e.g. after action 506.

### Action 500a

The encoder 110 may receive, from the decoder 120, an indication indicative of capability to send the feedback message. The indication indicative of capability may be received using SDP. This action is similar to action 200b.

### Action 500b

The encoder 110 may receive, from the decoder 120, a request for inclusion, by the encoder 110, of at least one DPH SEI message in the CVS. The request may be received using SDP. This action is similar to action 200d.

### Action 500c

The encoder 110 may send, to the decoder 120, a request for configuration of the decoder 120 to send the feedback message. The request may be sent using SDP. This action is similar to action 200e.

### Action 501

The encoder 110 encodes pictures into the CVS. This action is similar to action 201.

### Action 502

The encoder 110 sends a picture of the CVS to a decoder 120. This action is similar to action 202.

### Action 503

The encoder 110 may determine a further indication indicative of the error in the picture, wherein the encoding 214 further is based on the further indication or the information further relates to the further indication. This action is similar to action 206.

### Action 504

The encoder 110 may store the further indication. This action is similar to action 207.

### Action 505

The encoder 110 may send the further indication. This action is similar to action 208.

### Action 506

The encoder 110 receives, from the decoder 120, a feedback message comprising information relating to an indication indicative of an error in the picture and identities of reference pictures of the decoder 120. This action is similar to action 213.

### Action 507

The encoder 110 encodes pictures into the CVS based on the information relating to the indication while using zero or more reference pictures indicated by the identities of the reference pictures. This action is similar to action 214.

The encoding of pictures into the CVS based on the information relating to the indication may comprise encoding the pictures into the CVS by using only one or more reference pictures for which the indication indicates that no error has been detected for said one or more reference pictures, or for which the indication indicative of the error and the further indication indicate that no error has been detected for said one or more reference pictures.

With reference to FIG. 6, a schematic block diagram of the encoder 110 is shown. The encoder 110 is configured to select zero or more reference picture to be used when encoding one or more pictures into a CVS.

As mentioned, the information of the feedback message may comprise the indication. The indication may comprise a hash value for the picture. The further indication may comprise a further hash value for the picture. The information of the feedback message may comprise an identifier for indicating that the picture is error-free or for indicating that the picture is erroneous. The feedback message may comprise a RTCP feedback message. The RTCP feedback message may comprise a Reference Picture Selection Indication RPSI message. The coded video sequence may be a HEVC compliant coded video sequence.

The encoder 110 may comprise a processing module 601, such as a means, one or more hardware modules and/or one or more software modules for performing the methods described herein.

The encoder 110 may further comprise a memory 602. The memory may comprise, such as contain or store, a computer program 603.

According to some embodiments herein, the processing module 601 comprises, e.g. ‘is embodied in the form of’ or ‘realized by’, a processing circuit 604 as an exemplifying hardware module. In these embodiments, the memory 602 may comprise the computer program 603, comprising computer readable code units executable by the processing circuit 604, whereby the encoder 110 is operative to perform the methods of FIG. 2a/b and/or FIG. 5.

In some other embodiments, the computer readable code units may cause the encoder 110 to perform the method according to FIG. 2a/b and/or 5 when the computer readable code units are executed by the encoder 110.

FIG. 6 further illustrates a carrier 605, comprising the computer program 603 as described directly above. The carrier 605 may be one of an electronic signal, an optical signal, a radio signal, and a computer readable medium.

In some embodiments, the processing module 601 comprises an Input/Output (I/O) unit 606, which may be exemplified by a receiving module and/or a sending module as described below when applicable.

In further embodiments, the encoder 110 and/or the processing module 601 may comprise one or more of an encoding module 610, a sending module 620, a receiving module 630, a determining module 640 and a storing module 650 as exemplifying hardware modules. In other examples, the aforementioned exemplifying hardware module may be implemented as one or more software modules.

Therefore, according to the various embodiments described above, the encoder 110 is operative to and/or the encoder 110, the processing module 601 and/or the encoding module 610 is configured to encode pictures into the CVS.

The encoder 110 is operative to and/or the encoder 110, the processing module 601 and/or the encoding module 610, or a further encoding module (not shown), is further configured to encode pictures into the CVS based on the information relating to the indication indicative of the error while using zero or more reference pictures indicated by the identities of the reference pictures.

The encoder 110 may be operative to and/or the encoder 110, the processing module 601 and/or the encoding module 610, or still another encoding module (not shown), may be configured to encode the pictures into the CVS by using only one or more reference pictures for which the indication indicates that no error has been detected for said one or more reference pictures, or for which the indication and the further indication indicate that no error has been detected for said one or more reference pictures.

The encoder 110 is operative to and/or the encoder 110, the processing module 601 and/or the sending module 620 is further configured to send a picture of the CVS to a decoder 120.

The encoder 110 may further be operative to and/or the encoder 110, the processing module 601 and/or the sending module 620 may further be configured to send the further indication.

Furthermore, the encoder 110 is operative to and/or the encoder 110, the processing module 601 and/or the receiving module 630 is further configured to receive, from the decoder 120, a feedback message comprising information relating to an indication indicative of an error in the picture and identities of reference pictures of the decoder 120.

The encoder 110 may be operative to and/or the encoder 110, the processing module 601 and/or the determining module 640 may be configured to determine a further indication indicative of the error in the picture. In these embodiments, the encoder 110 may be operative to and/or the encoder 110, the processing modules 601 and/or the encoding module 610, or yet another encoding module (not shown), may be configured to encode the pictures based on the further indication. Alternatively, the information further relates to the further indication as discussed above in conjunction with FIG. 2.

The encoder 110 may be operative to and/or the encoder 110, the processing module 601 and/or the storing module 650 may be configured to store the further indication.

The encoder 110 may be operative to and/or the encoder 110, the processing module 601 and/or the receiving module 630, or a further receiving module (not shown), may be configured to receive, from the decoder 120, an indication indicative of capability to send the feedback message. The indication indicative of capability is received using SDP, i.e. the encoder 110 may be configured to receive the indication indicative of capability using SDP.

The encoder 110 may be operative to and/or the encoder 110, the processing module 601 and/or the receiving module 630, or a still other receiving module (not shown), may further be configured to receive, from the decoder 120, a request for inclusion, by the encoder 110, of at least one DPH SEI message in the CVS. The request may be received using SDP.

The encoder 110 may further be operative to and/or the encoder 110, the processing module 601 and/or the sending module 620, or a still other sending module (not shown), may further be configured to send, to the decoder 120, a request for configuration of the decoder 120 to send the feedback message. The request may be sent using SDP.

As used herein, the term “processing module” may in some examples refer to a processing circuit, a processing unit, a processor, an Application Specific integrated Circuit (ASIC), a Field-Programmable Gate Array (FPGA) or the like. As an example, a processor, an ASIC, an FPGA or the like may comprise one or more processor kernels. In these examples, the processing module is thus embodiment by a hardware module. In other examples, the processing module may be embodied by a software module. Any such module, be it a hardware, software or combined hardware-software module, may be a determining means, estimating means, capturing means, associating means, comparing means, identification means, selecting means, receiving means, sending means or the like as disclosed herein. As an example, the expression “means” may be a module or a unit, such as a determining module and the like correspondingly to the above listed means.

As used herein, the expression “configured to” may mean that a processing circuit is configured to, or adapted to, by means of software configuration and/or hardware configuration, perform one or more of the actions described herein.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer readable medium” may be a Universal Serial Bus (USB) memory, a DVD-disc, a Blu-ray disc, a software module that is received as a stream of data, a Flash memory, a hard drive, a memory card, such as a MemoryStick, a Multimedia Card (MMC), etc.

As used herein, the term “computer readable code units” may be text of a computer program, parts of or an entire binary file representing a computer program in a compiled format or anything there between.

As used herein, the terms “number”, “value” may be any kind of digit, such as binary, real, imaginary or rational number or the like. Moreover, “number”, “value” may be one or more characters, such as a letter or a string of letters. “number”, “value” may also be represented by a bit string.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1. A method, performed by a decoder, for supporting selection, by an encoder, of zero or more reference pictures to be used by the encoder when encoding one or more pictures to create a Coded Video Sequence, “CVS”, wherein the method comprises:
receiving a picture of the CVS from the encoder;
determining an indication indicative of an error in the picture; and
sending, to the encoder, a feedback message for supporting selection, by the encoder, of zero or more reference pictures to be used by the encoder when encoding one or more pictures to create the CVS, wherein the feedback message comprises information relating to the indication indicative of the error.

2. The method according to claim 1, wherein the method comprises: storing the indication indicative of the error.

3. The method according to claim 1, wherein the method comprises: detecting an error in the picture, wherein the sending of the feedback message is performed in response to the detection of the error in the picture.

4. The method according to claim 1, wherein the method comprises:
sending, to the encoder, an indication indicative of capability to send the feedback message.

5. (canceled)

6. The method according to claim 1, wherein the method comprises:
sending, to the encoder, a request for inclusion, by the encoder, of at least one DPH SEI message in the CVS.

7. (canceled)

8. The method according to claim 1, wherein the method comprises:
receiving, from the encoder, a request for configuration of the decoder to send the feedback message.

9. (canceled)

10. The method according to claim 1, wherein the indication indicative of the error comprises a hash value for the picture.

11. The method according to claim 1, wherein the information of the feedback message comprises the indication.

12. The method according to claim 1, wherein the feedback message comprises identities of reference pictures.

13-21. (canceled)

22. A method, performed by an encoder for selecting zero or more reference picture to be used when encoding one or more pictures into a Coded Video Sequence, “CVS”, wherein the method comprises:
encoding pictures into the CVS;
sending a picture of the CVS to a decoder;
receiving, from the decoder, a feedback message comprising information relating to an indication indicative of an error in the picture and identities of reference pictures of the decoder; and
encoding pictures into the CVS based on the information relating to the indication indicative of the error while using zero or more reference pictures indicated by the identities of the reference pictures.

23. The method according to claim 22, wherein the method further comprises:
determining a further indication indicative of the error in the picture, wherein the encoding further is based on the further indication or the information further relates to the further indication.

24. The method according to claim 22, wherein the method comprises:
receiving, from the decoder, an indication indicative of capability to send the feedback message.

25. (canceled)

26. The method according to claim 22, wherein the method comprises:
receiving, from the decoder, a request for inclusion, by the encoder, of at least one DPH SEI message in the CVS.

27. (canceled)

28. The method according to claim 22, wherein the method comprises:
sending, to the decoder a request for configuration of the decoder to send the feedback message.

29. (canceled)

30. The method according to claim 22, wherein the information of the feedback message comprises the indication.

31. The method according to claim 22, wherein the indication comprises a hash value for the picture.

32-34. (canceled)

35. The method according to claim 22, wherein the encoding of pictures into the CVS based on the information relating to the indication comprises encoding the pictures into the CVS by using only one or more reference pictures for which the indication indicates that no error has been detected for said one or more reference pictures, or for which the indication and the further indication indicate that no error has been detected for said one or more reference pictures.

36-39. (canceled)

40. A decoder configured to support selection, by an encoder, of zero or more reference pictures to be used by the encoder when encoding one or more pictures to create a Coded Video Sequence, CVS, wherein the decoder is configured to:
receive a picture of the CVS from the encoder;
determine an indication indicative of an error in the picture; and
send, to the encoder, a feedback message for supporting selection, by the encoder, of zero or more reference pictures to be used by the encoder when encoding one or more pictures to create the CVS, wherein the feedback message comprises information relating to the indication.

41. The decoder according to claim 40, wherein the decoder is configured to store the indication.

42. The decoder according to claim 40, wherein the decoder is configured to detect an error in the picture, wherein the decoder is configured to send the feedback message in response to the detection of the error in the picture.

43. The decoder according to claim 40, wherein the decoder is configured to send, to the encoder, an indication indicative of capability to send the feedback message.

44. (canceled)

45. The decoder according to claim 40, wherein the decoder is configured to send, to the encoder (110), a request for inclusion, by the encoder, of at least one DPH SEI message in the CVS.

46. (canceled)

47. The decoder according to claim 40, wherein the decoder is configured to receive, from the encoder, a request for configuration of the decoder to send the feedback message.

48. (canceled)

49. The decoder according to claim 40, wherein the indication comprises a hash value for the picture.

50. The decoder according to claim 40, wherein the information of the feedback message comprises the indication.

51. The decoder according to claim 40, wherein the feedback message comprises identities of reference pictures.

52-60. (canceled)

61. An encoder configured to select zero or more reference picture to be used when encoding one or more pictures into a Coded Video Sequence, “CVS”, wherein the encoder is configured to:
encode pictures into the CVS;
send a picture of the CVS to a decoder;
receive, from the decoder, a feedback message comprising information relating to an indication indicative of an error in the picture and identities of reference pictures of the decoder; and
encode pictures into the CVS based on the information relating to the indication while using zero or more reference pictures indicated by the identities of the reference pictures.

62. The encoder according to claim 61, wherein the encoder is configured to determine a further indication indicative of the error in the picture, wherein the encoder is configured to encode the pictures based on the further indication, or the information further relates to the further indication.

63. The encoder according to claim 61, wherein the encoder is configured to receive, from the decoder, an indication indicative of capability to send the feedback message.

64. (canceled)

65. The encoder according to any one of claim 61, wherein the encoder is configured to receive, from the decoder, a request for inclusion, by the encoder, of at least one DPH SEI message in the CVS.

66. (canceled)

67. The encoder according to claim 61, wherein the encoder is configured to send, to the decoder, a request for configuration of the decoder to send the feedback message.

68. (canceled)

69. The encoder according to claim 61, wherein the information of the feedback message comprises the indication.

70. The encoder according to claim 61, wherein the indication comprises a hash value for the picture.

71-73. (canceled)

74. The encoder according to claim 62, wherein the encoder is configured to encode the pictures into the CVS by using only one or more reference pictures for which the indication indicates that no error has been detected for said one or more reference pictures, or for which the indication and the further indication indicate that no error has been detected for said one or more reference pictures.

75-82. (canceled)
